(19) United States
(12) Patent Application Publication
(10) Pub. No.: US 2026/0172767 A1
(43) Pub. Date: Jun. 18, 2026

(54) METHOD AND MEASUREMENT DEVICE

(71) Applicant: Rohde & Schwarz GmbH & Co. KG, München (DE)

(72) Inventors: Rene WOLF, Unterschleißheim (DE); Christoph NUFER, Rosenheim (DE)

(21) Appl. No.: 18/979,231

(22) Filed: Dec. 12, 2024

(51) Int. Cl. H04R 29/00; G06F 3/16

(52) U.S. Cl. CPC H04R 29/00; G06F 3/165

(57) ABSTRACT

Measuring audio delay is described using a measurement device and a method. The method can include providing a measurement audio signal to an electronic communication device to be tested, acquiring a transmitted audio signal at an output section of a signal path, the transmitted audio signal being formed by the measurement audio signal being transmitted by the electronic communication device through the signal path to the output section, and determining the audio delay based on the measurement audio signal and the transmitted audio signal, where the measurement audio signal includes an activation sequence, and at least one sweep pair including a raising frequency audio tone sweep and a falling frequency audio tone sweep.

### TECHNICAL FIELD

The disclosure relates to a method for measuring audio delay and a respective measurement device.

### BACKGROUND

Although applicable to any type of delay measurement, the present disclosure will mainly be described in conjunction with measurement of audio delay in telecommunication applications.

Voice calls in telecommunication applications may have a large variety of possibly configurations that impact the processing delay and signal processing characteristics.

In the mobile radio test domain, users, therefore, want to measure the audio delay of their device under test, e.g. mobile phones doing a voice call, and make sure that the audio delay corresponds to the respective requirements.

Performing such audio delay measurements, especially, in cases where modern compression algorithms and codecs are being used in telecommunication applications, is a difficult task because such modern compression algorithms and codecs may remove test signals from the transmission. The test signals may also be removed by additional pre-processing done in a device under test.

Accordingly, there is a need for improving audio delay measurements in telecommunication applications.

### SUMMARY

The above stated problem is solved by the features of the independent claims. It is understood, that independent claims of a claim category may be formed in analogy to the dependent claims of another claim category.

Accordingly, it is provided:

A method for measuring audio delay, the method comprising providing a measurement audio signal to an electronic communication device to be tested, acquiring a transmitted audio signal at an output section of a signal path, the transmitted audio signal being formed by the measurement audio signal being transmitted by the electronic communication device through the signal path to the output section, and determining the audio delay based on the measurement audio signal and the transmitted audio signal, wherein the measurement audio signal comprises a predetermined activation sequence, e.g., a sequence with a constant frequency audio tone, and at least one sweep pair comprising a raising frequency audio tone sweep and a falling frequency audio tone sweep.

Further, it is provided:

A measurement device for measuring audio delay, the measurement device comprising an output interface, and an input interface, and a processor configured to output a measurement audio signal to an electronic communication device to be tested via the output interface, acquire a transmitted audio signal at an output section of a signal path via the input interface, the transmitted audio signal being formed by the measurement audio signal being transmitted by the electronic communication device through the signal path to the output section, and determine the audio delay based on the measurement audio signal and the transmitted audio signal. The processor is further configured to output the measurement audio signal comprising a predetermined activation sequence, e.g., a sequence with a constant frequency audio tone, and at least one sweep pair comprising a raising frequency audio tone sweep and a falling frequency audio tone sweep.

The present disclosure is based on the finding that commonly used test signals for measuring audio delay may fail to provide an acceptable result in modern communication systems.

Existing solutions usually comprise one of two possible variations of test signals. One possible type of test signals may be a form of pseudo noise sequence, also called PN sequence, as for example solutions based on ITU-T P.501 section 3.2.2 and section 7.2.1. Further possible types of test signals may comprise some form of human speech sequences, as for example solutions based on ITU T22-SG12-C0221 (https://www.itu.int/dms_ties/itu-t/md/22/sg12/c/T22-SG12-C-0221!!MSW-E. docx).

To measure the signal delay across an audio transmission path, usually a test signal is played into the path input and recorded at the path output. In such a setup the recorder and player need to be synchronized in order to identify the delay of the transmission path by finding the offset of the test signal in the recording. To find the test signal in the recording, a cross-correlation may be used.

It is known that real world transmission paths are not ideal and do degrade the signal that is transmitted at least to some extend. For a purely analog signal path, exemplarily noise may be added, the signal may be distorted and bandwidth limitations may apply to the signal on the signal path. Such possible signal degradations and the application of the cross-correlation function puts multiple requirements on the test signal:

The test signal has to have poor auto-correlation properties, to produce a single distinct peak only where the test signal is actually positioned with the cross-correlation function being applied. Further, the test signal has to be robust against signal degradation along the signal path.

Usually, a pseudo-random noise sequence is used as a test signal.

However, when applying a pseudo-random noise sequence to a transmission path that contains a digital compression codec, additional problems may arise. In particular systems that are optimized for speech transmission, such as mobile telephony, or other forms of low data rate digital speech codecs, pseudo-random noise sequences tend to produce poor results.

The specific reasons vary from system to system, but can still be summarized generally as follows. A pseudo-random noise sequence does by design look like noise, and is very different from actual human speech. Systems designed for low bit rate transmission of speech, usually go to great lengths to filter out any non-speech parts of a signal, before encoding and transmission.

This ensures that the limited bit rate is used most efficiently for the speech part of the signal, and in most cases strongly reduces or entirely removes the information from pseudo-random noise sequences.

While it has been tried to create special pseudo-random noise sequences or to use actual human speech as test signals, these solutions may not overcome all the existing problems.

Modern mobile phones, for example, employ ever more sophisticated signal conditioning before feeding an audio signal to the encoder. Mobile phones on the market in the year 2024 have been observed filtering out the entire pseudo-random noise sequence that follows after an activation pattern, making delay measurements impossible. Further, such sequences tend to be some seconds in length, making finding them more computationally expensive, and thus slow.

When using actual human speech as test signal such a test signal needs to be very long, as speech tends to have stronger auto-correlation than pseudo-random noise sequences, making the peaks in lag space washed out and not as clear.

The present invention, therefore, provides a method that uses a novel measurement audio signal to measure the audio delay in a respective signal path.

The method comprises providing the measurement audio signal to an electronic communication device to be tested, also called a DUT or device under test. The DUT will emit the received measurement audio signal into a signal path. A transmitted audio signal is formed by the measurement audio signal being transmitted by the electronic communication device through the signal path to an output section. The transmitted audio signal is then acquired at an output section of the signal path. Based on the measurement audio signal and the transmitted audio signal the audio delay is determined. For example, the cross-correlation between the measurement audio signal and the transmitted audio signal may be calculated.

The novel type of measurement audio signal is an audio signal that comprises a predetermined activation sequence, e.g., an audio sequence with a constant frequency audio tone, and at least one sweep pair comprising a raising frequency audio tone sweep and a falling frequency audio tone sweep.

The term “sweep” in the context of the present disclosure refers to a varying frequency of the respective signal, e.g., a varying frequency of the measurement audio signal, especially a respective signal section of the measurement audio signal. The term “signal section” in the context of the present disclosure refers to any section of the measurement audio signal that is explicitly disclosed herein as being part of the measurement audio signal, e.g., the constant frequency audio tone, the raising frequency audio tone sweep, and the falling frequency audio tone sweep. The term “sweep pair” in the context of the present disclosure is to be understood as a pair of a raising frequency audio tone sweep and a falling frequency audio tone sweep. In the measurement audio signal at least one such pair may be present, while any other, higher number of sweep pairs may be present.

The predetermined activation sequence may comprise a constant frequency audio tone that comprises the same frequency over a specific period of time. Other embodiments of the activation sequence that have a similar effect in the DUT may also be provided. The raising frequency audio tone sweep may comprise a signal with a frequency that raises over time. The falling frequency audio tone sweep may comprise a signal with a frequency that lowers or falls over time. Further, the measurement audio signal may comprise a constant or a varying amplitude.

Such a novel kind of measurement audio signal is inherently bias-free, i.e., it has no DC component, which favorably supports signal processing and speech coding. Former test signals, like that propose the ITU-T P.501 only achieve this by doubling its signal in an inverted form, also doubling the test signal length, and increasing test time.

The falling frequency audio tone sweep alone provides all the data required for cross-correlation. Using only the falling frequency audio tone sweep is much less computationally expensive than using an entire pseudo-random noise sequence, but still yields comparable results on modern mobile phones and their complex signal conditioning. In addition, the cross-correlation quality of the falling frequency audio tone sweep is better compared to 1 word and 2 word actual human speech test data as suggested in T 22-SG12-C0221, by a factor of 2.5 and 2.3 respectively.

In addition, the measurement audio signal is easily identifiable in a frequency domain waterfall display, and can help with diagnosing various other problems with real world setups, as will be explained below.

It is understood, that the method may comprise generating, or the measurement device may be configured to generate the measurement audio signal each time the measurement audio signal is provided to the DUT. In other embodiments, the measurement audio signal may be stored as file and may be replayed when needed. The measurement audio signal may be stored on a non-transitory computer readable medium, e.g., a memory, that stores the data comprises the measurement audio signal.

In embodiments, the method may be implemented as a computer implemented method that is executed by a respective measurement device. The measurement device may comprise a processor that executes instructions that when executed by the processor cause the processor to perform the method according to the present disclosure.

Such a measurement device may comprise respective interfaces that may output the measurement audio signal to the DUT, and that may acquire the transmitted audio signal. Such interfaces may e.g., comprise audio interfaces.

The measurement device may, in embodiments, be implemented as or in any kind of measurement application device.

A measurement application device according to the present disclosure may comprise any device that may be used in a measurement application to acquire an input signal or to generate an output signal, or to perform additional or supporting functions in a measurement application. A measurement application device may also comprise or be implemented as program application or program applications, also called measurement program application or measurement program applications, that may be executed on a computer device and that may communicate with other measurement application devices in order to perform a measurement task. A measurement application, also called measurement setup, may e.g., comprise at least one or multiple different measurement application devices for performing electric, magnetic, or electromagnetic measurements, especially on single devices under test. A measurement application device according to the present disclosure may be configured to perform such electric, magnetic, or electromagnetic measurements e.g., in a measurement laboratory or in a production facility in the respective production line on a device under test, DUT. An exemplary measurement application or measurement setup may serve to qualify the single devices under test i.e., to determine the proper electrical operation of the respective devices under test.

Measurement application devices to this end may comprise at least one signal acquisition section for acquiring electric, magnetic, or electromagnetic signals to be measured from a device under test, or at least one signal generation section for generating electric, magnetic, or electromagnetic signals that may be provided to the device under test. Such a signal acquisition section may comprise, but is not limited to, a front-end for acquiring, filtering, and attenuating or amplifying electrical signals. The signal generation section may comprise, but is not limited to, respective signal generators, amplifiers, and filters. In embodiments, the signal acquisition is performed via the signal acquisition section in a wired or contact-based manner or fashion. To this end, a respective measurement probe may be coupled to the measurement application device via a respective cable. In embodiments, the signal generation and emission is performed via the signal generation section in a wired or contact-based manner or fashion. To this end, a respective signal output probe may be coupled to the measurement application device via a respective cable, or the signal may be output directly via the cable e.g., to a device under test. In further embodiments, the signal acquisition is performed via the signal acquisition section in a wireless or contact-less manner or fashion, e.g. via respective antennas, also called over-the-air or OTA. In further embodiments, the signal generation and emission is performed in a wireless or contact-less manner or fashion, e.g. via respective antennas, also called over-the-air or OTA. A combination of contact-based signal acquisition, contact-less signal acquisition, contact-based signal generation and emission is, and contact-less signal generation and emission is possible.

Further, when acquiring signals, measurement application devices may comprise a signal processing section that may process the acquired signals. Processing may comprise converting the acquired signals from analog to digital signals or vice versa, and any other type of digital signal processing, for example, converting signals from the time-domain into the frequency-domain.

The measurement application devices may also comprise a user interface to display the acquired signals to a user and allow a user to control the measurement application devices. Of course, a housing may be provided that comprises the elements of the measurement application device. It is understood, that further elements, like power supply circuitry, and communication interfaces may be provided.

A measurement application device may be a stand-alone device that may be operated without any further element in a measurement application to perform tests on a device under test. Of course, communication capabilities may also be provided for the measurement application device to interact with other measurement application devices.

A measurement application device may comprise, for example, a signal acquisition device e.g., an oscilloscope, especially a digital oscilloscope, a spectrum analyzer, a vector network analyzer, or a mobile radio communication tester. Such a measurement application device may also comprise a signal generation device e.g., a signal generator, especially an arbitrary signal generator, also called arbitrary waveform generator, or a vector signal generator. Further possible measurement application devices comprise devices like calibration standards, or measurement probe tips.

Of course, at least some of the possible functions, like signal acquisition and signal generation, may be combined in a single measurement application device.

In embodiments, the measurement application device may comprise pure data acquisition devices that are capable of acquiring an input signal and of providing the acquired input signal as digital input signal to a respective data storage or application server. Such pure data acquisition devices not necessarily comprise a user interface or display. Instead, such pure data acquisition devices may be controlled remotely e.g., via a respective data interface, like a network interface or a USB interface. The same applies to pure signal generation devices that may generate an output signal without comprising any user interface or configuration input elements. Instead, such signal generation devices may be operated remotely via a data connection.

Further embodiments of the present disclosure are subject of the further dependent claims and of the following description, referring to the drawings.

In the following, the dependent claims referring directly or indirectly to claim 1 are described in more detail. For the avoidance of doubt, the features of the dependent claims relating to independent claim 1 can be combined in all variations with each other and the disclosure of the description is not limited to the claim dependencies as specified in the claim set. Further, the features of the dependent claims referring to independent claim 1 may be combined with any of the features of the other independent claims or the dependent claims relating to any one of the other independent claims. In a respective method, respective method steps may perform the function of the respective apparatus elements, and in a respective apparatus, respective apparatus elements may perform the respective method steps.

In an embodiment, which can be combined with all other embodiments mentioned above or below, the measurement audio signal may be a continuous signal.

The term “continuous signal” is to be understood as the measurement audio signal comprising no discontinuities, steps or jumps, especially in the time domain. Such discontinuities, steps or jumps would be atypical for natural speech. Further, such discontinuities, steps or jumps would cause high frequency harmonics, which would increase the chances of the respective signal section being filtered out prior to encoding by a modern communication device.

In a further embodiment, which can be combined with all other embodiments mentioned above or below, the measurement audio signal may comprise a sine signal.

The measurement audio signal while not being limited to this implementation may comprise a pure sine or at least sine-like signal. Different sections of the measurement audio signal may comprise different types of signals.

In an exemplary activation sequence the sine signal may have a fixed frequency, in the raising frequency audio tone sweep, and the falling frequency audio tone sweep the, and the final raising sweep (explained in more detail below) the sine signal may have a varying frequency.

Especially in combination with the measurement audio signal being a continuous signal, the end frequency of a signal section may be the starting frequency of the next signal section.

In another embodiment, which can be combined with all other embodiments mentioned above or below, at least one of the start frequency and the end frequency of at least one of the activation sequence, the raising frequency audio tone sweep of the at least one sweep pair, and the falling frequency audio tone sweep of the at least one sweep pair, and the final raising sweep is a prime number or a number with a predetermined number of factors. In general all prime numbers may be used. However for audio delay measurement applications, especially prime numbers that lie within or near the common range of human speech may be used.

In embodiments, each one of the start frequency and the end frequency of each one of the activation sequence, the raising frequency audio tone sweep of the at least one sweep pair, and the falling frequency audio tone sweep of the at least one sweep pair is a prime number.

Using prime numbers as the start and end frequencies of single signal sections of the measurement audio signal reduces the auto-correlation properties of the measurement audio signal, and, therefore, improves detectability of the measurement audio signal in the acquired transmitted audio signal.

If the measurement audio signal is provided with discontinuities, steps or jumps, the frequencies at this discontinuities, steps or jumps may comprise prime numbers.

If a number with a predetermined number of factors is used, the predetermined number may be limited to a specific maximum number of factors. The term “factors” refers to the factors that result from the decomposition of the number into integer factors.

In an embodiment, which can be combined with all other embodiments mentioned above or below, each one of the prime numbers or numbers with a predetermined number of factors may be unique in the measurement audio signal.

The term “unique” in this context refers to the same prime number being used only once in the whole measurement audio signal as a start or end frequency of any one of the signal sections of the measurement audio signal.

Using each prime number, and consequently, each start or end frequency only once in the measurement audio signal further reduces the auto-correlation properties of the measurement audio signal. It is understood that the sweeps may cross the respective frequencies, but may not start or end with such a frequency that is already used as start or end frequency of another signal section.

In an embodiment, which can be combined with all other embodiments mentioned above or below, the frequency slopes of the raising frequency audio tone sweep, and the falling frequency audio tone sweep of the at least one sweep pair may be unique.

The slopes or inclinations of the raising frequency audio tone sweep of the at least one sweep pair, and the falling frequency audio tone sweep of the at least one sweep pair may for all sweep pairs of the measurement audio signal be unique. That means that a specific slope or inclination is used only once in the respective measurement audio signal.

Using different slopes for all of the sweeps in the measurement audio signal further reduces the auto-correlation properties of the measurement audio signal.

Further, as will be explained with regard to the figures below, using unique slopes allows easily detecting problems in the signal path visually.

In embodiments, a least one of the measurement audio signal, and the transmitted audio signal may be shown on a display to a user. For example, a frequency domain waterfall diagram may be shown comprising at least one of the measurement audio signal and the measurement audio signal (see FIGS. 3 and 4).

In an embodiment, which can be combined with all other embodiments mentioned above or below, the activation sequence may comprise at least one of a duration between 10 ms and 100 ms, a frequency, especially a variable or constant frequency, between 300 Hz and 700 Hz, a frequency, especially a variable or constant frequency, present in human speech, a single frequency of a DTMF tone, and the frequencies of a DTMF tone.

The activation sequence serves for priming the DUT and to achieve a clean transition from any preceding silence or audio that may be provided to the DUT.

The term DTMF tone refers to dual tone multi frequency tones that comprise two overlaid frequencies. A single one of these frequencies may be used, or in case that a full DTMF tone is used, two different frequencies may be overlaid in the activation sequence to form the respective DTMF tone.

In another embodiment, which can be combined with all other embodiments mentioned above or below, the raising frequency audio tone sweep of the at least one sweep pair may comprise at least one of a duration between 100 ms and 300 ms, a start frequency between 300 Hz and 700 Hz, a start frequency that is the same as the end frequency of the activation sequence or a preceding falling frequency audio tone sweep, and an end frequency between 2500 Hz and 3500 Hz.

The start frequency of the raising frequency audio tone sweep may be in the lower range of a human voice. In embodiments, the start frequency of the raising frequency audio tone sweep may be the same as the end frequency of the activation sequence in order to provide a continuous measurement audio signal.

The end frequency may be chosen to be at the upper range or frequency limit of the respective codec used in the DUT. For narrow band codecs the end frequency may be, e.g., 2500 Hz or 3000 Hz.

In an embodiment, which can be combined with all other embodiments mentioned above or below, the falling frequency audio tone sweep of the at least one sweep pair may comprise at least one of a duration between 50 ms and 150 ms, a duration that is shorter than that of the raising frequency audio tone sweep, a start frequency between 2500 Hz and 3500 Hz, a start frequency that is the same as the end frequency of the raising frequency audio tone sweep, and an end frequency between 300 Hz and 700 Hz.

The duration of the falling frequency audio tone sweep may be chosen to be shorter than that of the raising frequency audio tone sweep.

Any duration of any one of the sections of the measurement audio signal may be chosen to be a prime number, e.g., in milliseconds or samples.

Generally, the frequencies and sweep times or slopes in the measurement audio signal may be chosen to fall within common properties of human speech, thus making it sound more speech-like. This reduces the chances of the measurement audio signal being removed by a respective codec.

Generally, using prime numbers for frequencies and durations further reduces the auto-correlation properties of the measurement audio signal.

In an embodiment, which can be combined with all other embodiments mentioned above or below, the measurement audio signal may comprise at least two sweep pairs.

The raising frequency audio tone sweep and the falling frequency audio tone sweep may be provided multiple times in different sweep pairs to lengthen the measurement audio signal in case more test data is needed for very low bit rate codecs or more sophisticated signal conditioning prior to encoding.

In a further embodiment, which can be combined with all other embodiments mentioned above or below, the measurement audio signal may further comprise a final raising sweep after the at least one sweep pair.

In another embodiment, which can be combined with all other embodiments mentioned above or below, the final raising sweep may comprise at least one of a duration of at least 100 ms, a start frequency between 300 Hz and 700 Hz, a start frequency that is the same as the end frequency of the preceding falling frequency audio tone sweep, and an end frequency between 20000 Hz and 30000 Hz.

The final raising sweep may be a raising sweep that has an end frequency in the upper limit of the human audible range. Most speech codec configurations have a much more limited bandwidth as speech tends to have very little information above 8 kHz. However limiting the audio bandwidth requires down sampling and appropriate anti-aliasing filters in the input signal chain of the respective DUT. The final raising sweep may be used to verify the correct bandwidth settings in a DUT, for example 4 kHz, also called narrow band. An indication about the filtering quality may be given by checking for aliasing.

In embodiments, the duration of the final raising sweep may be about 400 ms, the start frequency may be 300 Hz and the end frequency may be 25000 Hz, or 25 kHz.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a flow diagram of an embodiment of a method according to the present disclosure;

FIG. 2 shows a block diagram of an embodiment of a measurement device according to the present disclosure;

FIG. 3 shows a waterfall diagram of an embodiment of a measurement audio signal according to the present disclosure;

FIG. 4 shows a waterfall diagram of an embodiment of a transmitted audio signal according to the present disclosure;

FIG. 5 shows a block diagram of an embodiment of a measurement application device that may implement a measurement device according to the present disclosure; and

FIG. 6 shows a block diagram of an embodiment of a measurement application device that may implement a measurement device according to the present disclosure.

In the figures like reference signs denote like elements unless stated otherwise.

### DETAILED DESCRIPTION OF THE DRAWINGS

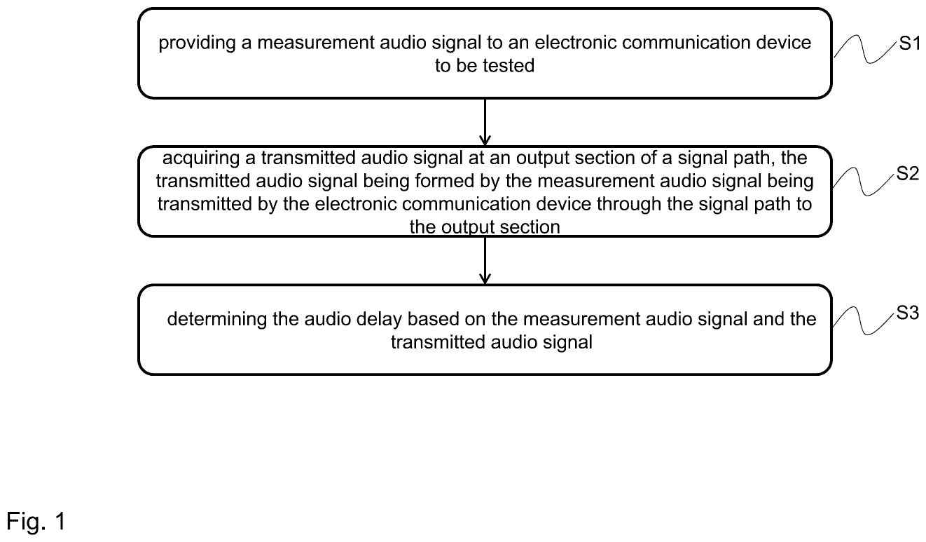

FIG. 1 shows a flow diagram of a method for measuring audio delay, especially in a telecommunication system.

The method comprises providing S1 a measurement audio signal to an electronic communication device to be tested, acquiring S2 a transmitted audio signal at an output section of a signal path, the transmitted audio signal being formed by the measurement audio signal being transmitted by the electronic communication device through the signal path to the output section, and determining S3 the audio delay based on the measurement audio signal and the transmitted audio signal.

For use in the method, a specific measurement audio signal is provided that comprises an activation sequence, e.g., an audio signal with a constant frequency audio tone, and at least one sweep pair comprising a raising frequency audio tone sweep and a falling frequency audio tone sweep. Multiple sweep pairs are possible. The measurement audio signal may further comprise a final raising sweep after the at least one sweep pair. The measurement audio signal may be provided as a continuous audio signal. Further, the least one of the sections of the measurement audio signal may comprise a sine signal or a sine-like signal.

While the described signal sections may directly follow each other as described, it is understood, that further signal sections, e.g., between the activation sequence and the raising frequency audio tone sweep, or between the raising frequency audio tone sweep and the falling frequency audio tone sweep, or the falling frequency audio tone sweep and a following raising frequency audio tone sweep or the final raising sweep, are not excluded. Such signal sections may comprise a constant frequency signal, or may comprise a varying frequency signal.

All the frequencies or at least some of the frequencies used for the sections of the measurement audio signal may be frequencies that are prime numbers, like for example 199 Hz up to 30011 Hz, wherein lower prime number frequencies and higher prime number frequencies are possible. Instead of prime numbers also numbers with a predetermined number of factors may be used, wherein the predetermined number is lower than a respective threshold, like a number between 1 to 10.

The used prime numbers or the numbers with a predetermined number of factors may be unique in the measurement audio signal. That means that each one of these numbers is used only once as a start or end frequency or as the constant frequency of the activation sequence. Also, the frequency slopes of the raising frequency audio tone sweep, and the falling frequency audio tone sweep of the at least one sweep pair may be chosen to be unique in the measurement audio signal.

The activation sequence may comprises at least one of a duration between 10 ms and 100 ms, a frequency between 300 Hz and 700 Hz, especially a frequency present in human speech, a single frequency of a DTMF tone, and the frequencies of a DTMF tone.

The raising frequency audio tone sweep of the at least one sweep pair may comprise at least one of a duration between 100 ms and 300 ms, a start frequency between 300 Hz and 700 Hz, especially a start frequency that is the same as the end frequency of the activation sequence or a preceding falling frequency audio tone sweep, and an end frequency between 2500 Hz and 5000 Hz.

The falling frequency audio tone sweep of the at least one sweep pair may comprise at least one of a duration between 50 ms and 150 ms, especially a duration that is shorter than that of the raising frequency audio tone sweep, a start frequency between 5000 Hz and 2500 Hz, especially a start frequency that is the same as the end frequency of the raising frequency audio tone sweep, and an end frequency between 300 Hz and 700 Hz.

The final raising sweep may comprise at least one of a duration of at least 100 ms, a start frequency between 300 Hz and 700 Hz, especially a start frequency that is the same as the end frequency of the preceding falling frequency audio tone sweep, and an end frequency between 20000 Hz and 30000 Hz.

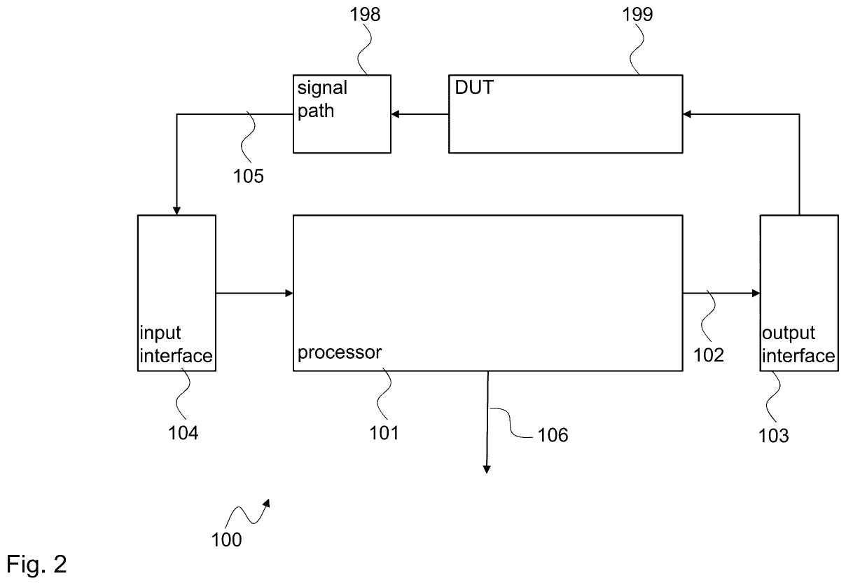

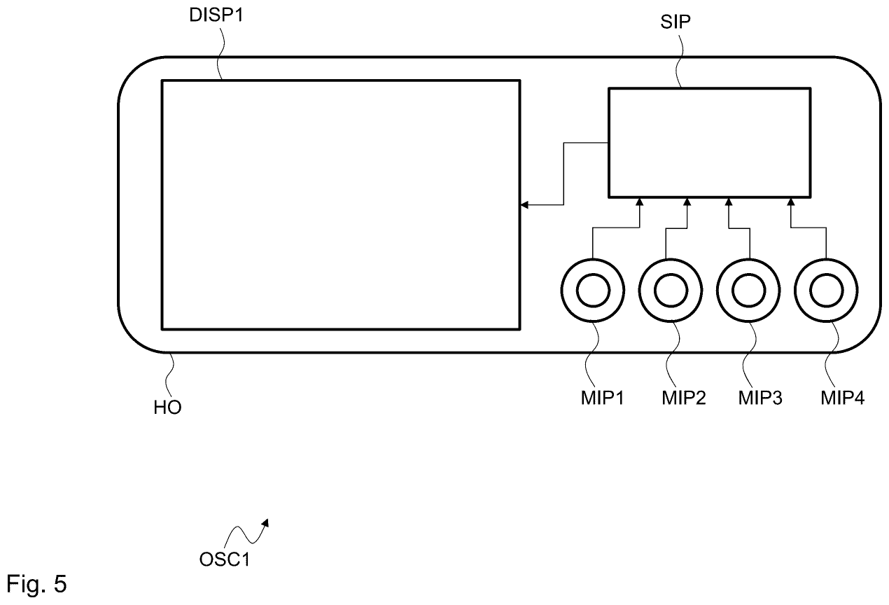

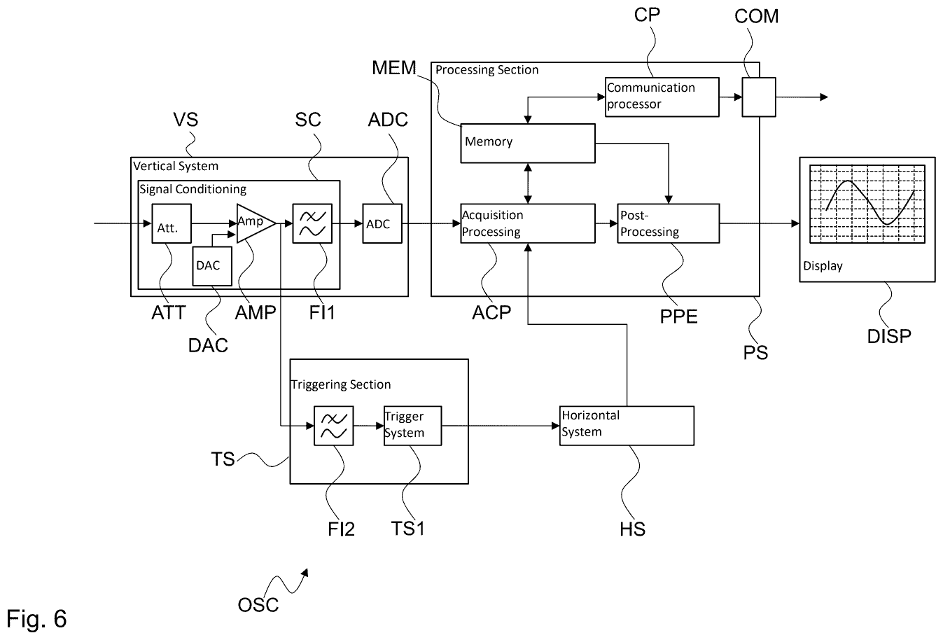

FIG. 2 shows a block diagram of a measurement device 100 for measuring audio delay 106. The measurement device 100 may be provided as a standalone device or may be integrated into a measurement application device as exemplarily shown in FIGS. 5 and 6.

The measurement device 100 comprises a processor 101 that is coupled to an output interface 103, and an input interface 104.

For performing a measurement of an audio delay 106 in a DUT 199, or in a DUT 199 and a signal path 198 external to the DUT, the processor outputs a measurement audio signal 102 to the DUT 199 via the output interface 103. It is understood, that the signal path 198 or a part of the signal path 198 may also be provided between the output interface 103 and the DUT 199.The DUT 199 receives, and processes the measurement audio signal 102 and may directly output the processed measurement audio signal 102 as a transmitted audio signal 105 to the input interface 104. The measurement audio signal 102 after being processed by the DUT 199 may also be passed to a signal path 198, e.g., a telecommunication provider network, and may then be provided to the input interface 104 as transmitted audio signal 105.

The processor 101 acquires the transmitted audio signal 105 via the input interface 104. The transmitted audio signal 105 is in this stage formed by the measurement audio signal 102 being transmitted by the DUT 199 and optionally also through the signal path 198 to the input interface 104.

The processor 101 determines the audio delay 106 based on the measurement audio signal 102 and the transmitted audio signal 105. The processor 101 may e.g., calculate the cross-correlation between the measurement audio signal 102 and the transmitted audio signal 105, and may determine the audio delay 106 based on the result of the cross-correlation calculations.

The processor 101 may be configured to output the measurement audio signal 102 comprising an activation sequence, e.g., with a constant frequency audio tone, and at least one sweep pair comprising a raising frequency audio tone sweep and a falling frequency audio tone sweep.

Regarding the measurement audio signal 102 all the explanations provided regarding the measurement audio signal used in the method according to the present disclosure and any other explanations regarding the measurement audio signal apply mutatis mutandis to the measurement audio signal 102 used by the measurement device 100.

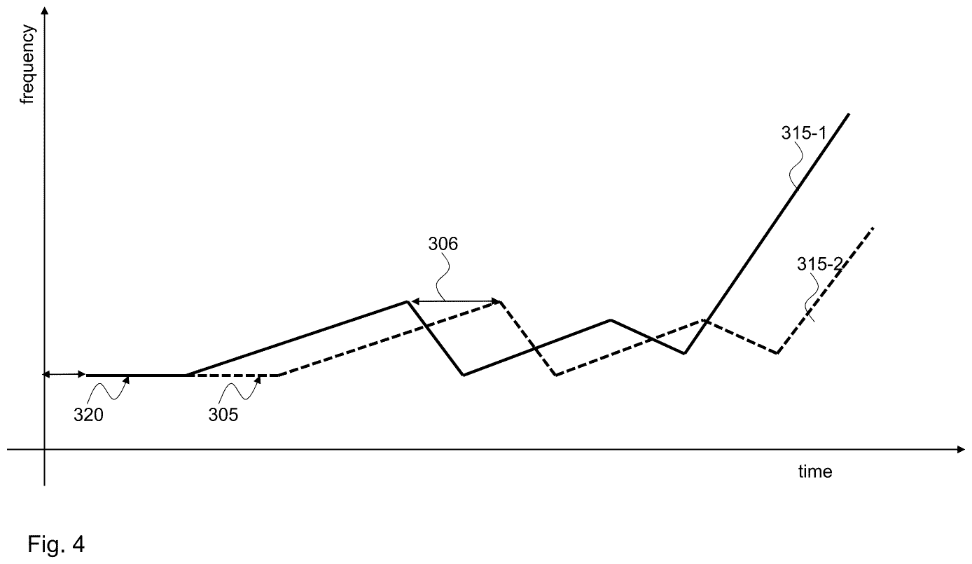

For providing the measurement audio signal to the DUT 199, the output interface 103 may exemplarily provide or implement the physical connection via a 4-pole headphone jack. Such headphone jacks often cause problems with cross talk. That is, the microphone input may couple signal parts onto the headphone output path. Such cross-talk problems may easily be detected visually, as will be explained with regard to FIG. 4.

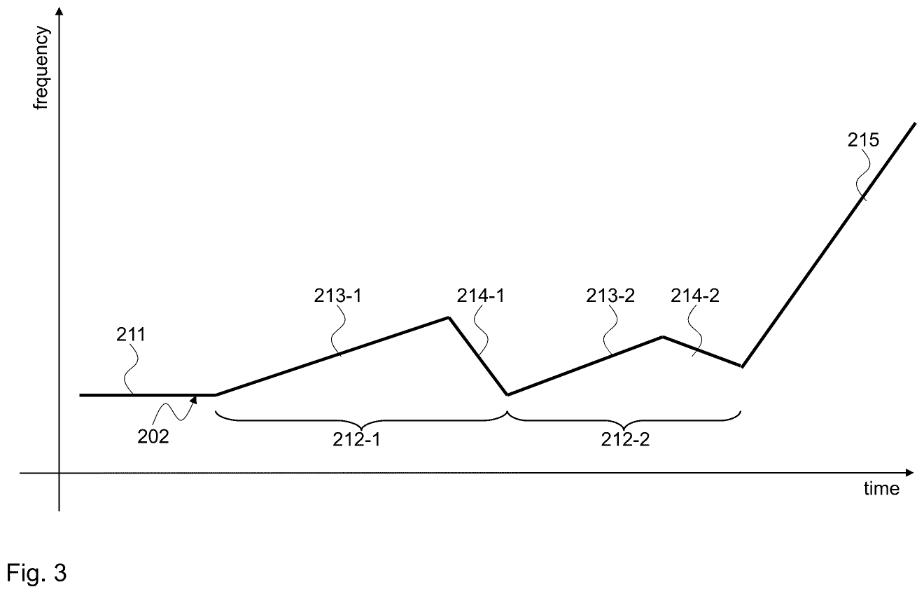

FIG. 3 shows a waterfall diagram of a measurement audio signal 202. The diagram shows time on the horizontal axis, and frequency on the vertical axis.

The measurement audio signal 202 comprises an activation sequence 211 that is followed by a first sweep pair 212-1, and a second sweep pair 212-2. It is understood that the second sweep pair 212-2 is optional and that more than two sweep pairs may be provided. Each one of the sweep pairs comprises a raising frequency audio tone sweep 213-1, 213-2 followed by a falling frequency audio tone sweep 214-1, 214-2. The last falling frequency audio tone sweep 214-2 is followed by a final raising sweep 215.

Regarding the measurement audio signal 202 all the explanations provided regarding the measurement audio signal used in the method or the measurement device according to the present disclosure and any other explanations regarding the measurement audio signal apply mutatis mutandis to the measurement audio signal 202.

FIG. 4 shows a waterfall diagram of a transmitted audio signal 305 (dotted line) used in an exemplary so called “netloop” delay test. In such a setup the communication network loops back any audio data that the DUT sends to the network back to the DUT. The delay is measured between the microphone input and the headphone output of the DUT, e.g. a cellular phone, mobile phone or smartphone. Such measurements give a result representing the combined processing delay of the up-link encoder path and the down-link decoder path.

The transmitted audio signal 305 is exemplarily based on the measurement audio signal 202 that is provided and processed by a DUT and a possible signal path. All explanations provided regarding measurement audio signal 202 and the transmitted audio signal provided herein apply mutatis mutandis.

As explained above, the physical connection may be established via a 4-pole headphone jack, which may cause cross talk. Consequently, the diagram of FIG. 4 shows the transmitted audio signal as cross-talk signal 320 that is the same as measurement audio signal 202, and the transmitted audio signal 305

As can be seen the two signals, i.e., the cross-talk signal 320 and the transmitted audio signal 305, are easy to discern visually, such that cross-talk problems can be identified easily.

In the present example, the cross talk is strong enough to use it as a manual reference for the delay measurement. By just determining the time distance between the cross-talk signal 320 and the transmitted audio signal 305, the audio delay 306 may be determined. This again may also help to narrow down problems with real world setups.

Usually, the input and output levels on such headphone jack connectors are not standardized and finding appropriate ones can be tricky. As the measurement audio signal may be provided such that it consists of sine sweeps only, clipping on the microphone input of the DUT, or later parts of the signal chain, can be easily identified by checking the diagram for harmonics, which the present example does not include.

The final raising sweep upwards to the end of the human hearing frequency range can be used to verify the correct bandwidth settings of a respective codec. Most speech codec configurations have a limited bandwidth since human speech tends to have very little information above 8 kHz. However limiting the audio bandwidth requires down sampling and appropriate anti-aliasing filters in the input signal chain of the DUT. In the shown example, a 4 kHz bandwidth, also called narrow band, is provided in the DUT, which can be seen in the waterfall diagram, since the final raising sweep 315-2 of the transmitted audio signal 305 stops below the final frequency of the final raising sweep 315-1 of the cross-talk signal 320, and therefore, the measurement audio signal 202.

FIG. 5 shows a block diagram of an oscilloscope OSC1 that may be used with an embodiment of a measurement device according to the present disclosure.

The oscilloscope OSC1 comprises a housing HO that accommodates four measurement inputs MIP1, MIP2, MIP3, MIP4 that are coupled to a signal processor SIP for processing any measured signals. The signal processor SIP is coupled to a display DISP1 for displaying the measured signals to a user.

Although not explicitly shown, it is understood, that the oscilloscope OSC1 may also comprise signal outputs. Such signal outputs may for example serve to output calibration signals. Such calibration signals allow calibrating the measurement setup prior to performing any measurement. The process of calibrating and correcting any measurement signals based on the calibration may also be called de-embedding and may comprise applying respective algorithms on the measured signals.

In the oscilloscope OSC1 the signal processor SIP or an additional processing element may perform the function of the measurement device according to the present disclosure, or may implement the method according to the present disclosure. Of course, a communication interface may be provided in the oscilloscope OSC1 for communication with other measurement application devices.

FIG. 6 shows a block diagram of an oscilloscope OSC that may be an implementation of a measurement application device according to the present disclosure. The oscilloscope OSC is implemented as a digital oscilloscope. However, the present disclosure may also be implemented with any other type of oscilloscope.

The oscilloscope OSC exemplarily comprises five general sections, the vertical system VS, the triggering section TS, the horizontal system HS, the processing section PS and the display DISP. It is understood, that the partitioning into five general sections is a logical partitioning and does not limit the placement and implementation of any of the elements of the oscilloscope OSC in any way. Although not explicitly shown, the oscilloscope OSC may also comprise a signal output section, e.g., for outputting calibration signals or the measurement audio signal.

The vertical system VS mainly serves for offsetting, attenuating and amplifying a signal to be acquired. The signal may for example be modified to fit in the available space on the display DISP or to comprise a vertical size as configured by a user.

To this end, the vertical system VS comprises a signal conditioning section SC with an attenuator ATT and a digital-to-analog-converter DAC that are coupled to an amplifier AMP. The amplifier AMP is coupled to a filter FI1, which in the shown example is provided as a low pass filter. The vertical system VS also comprises an analog-to-digital converter ADC that receives the output from the filter FI1 and converts the received analog signal into a digital signal.

The attenuator ATT and the amplifier AMP serve to scale the amplitude of the signal to be acquired to match the operation range of the analog-to-digital converter ADC. The digital-to-analog-converter DAC serves to modify the DC component of the input signal to be acquired to match the operation range of the analog-to-digital converter ADC. The filter FI1 serves to filter out unwanted high frequency components of the signal to be acquired.

The triggering section TS operates on the signal as provided by the amplifier AMP. The triggering section TS comprises a filter FI2, which in this embodiment is implemented as a low pass filter. The filter FI2 is coupled to a trigger system TS1.

The triggering section TS serves to capture predefined signal events and allows the horizontal system HS to e.g., display a stable view of a repeating waveform, or to simply display waveform sections that comprise the respective signal event. It is understood, that the predefined signal event may be configured by a user via a user input of the oscilloscope OSC.

Possible predefined signal events may for example include, but are not limited to, when the signal crosses a predefined trigger threshold in a predefined direction i.e., with a rising or falling slope. Such a trigger condition is also called an edge trigger. Another trigger condition is called “glitch triggering” and triggers, when a pulse occurs in the signal to be acquired that has a width that is greater than or less than a predefined amount of time.

In order to allow an exact matching of the trigger event and the waveform that is shown on the display DISP, a common time base may be provided for the analog-to-digital converter ADC and the trigger system TS1.

It is understood, that although not explicitly shown, the trigger system TS1 may comprise at least one of configurable voltage comparators for setting the trigger threshold voltage, fixed voltage sources for setting the required slope, respective logic gates like e.g., a XOR gate, and FlipFlops to generate the triggering signal.

The triggering section TS is exemplarily provided as an analog trigger section. It is understood, that the oscilloscope OSC may also be provided with a digital triggering section. Such a digital triggering section will not operate on the analog signal as provided by the amplifier AMP but will operate on the digital signal as provided by the analog-to-digital converter ADC.

A digital triggering section may comprise a processing element, like a processor, a DSP, a CPLD, an ASIC or an FPGA to implement digital algorithms that detect a valid trigger event.

The horizontal system HS is coupled to the output of the trigger system TS1 and mainly serves to position and scale the signal to be acquired horizontally on the display DISP.

The oscilloscope OSC further comprises a processing section PS that implements digital signal processing and data storage for the oscilloscope OSC. The processing section PS comprises an acquisition processing element ACP that is couple to the output of the analog-to-digital converter ADC and the output of the horizontal system HS as well as to a memory MEM and a post processing element PPE.

The acquisition processing element ACP manages the acquisition of digital data from the analog-to-digital converter ADC and the storage of the data in the memory MEM. The acquisition processing element ACP may for example comprise a processing element with a digital interface to the analog-to-digital converter ADC and a digital interface to the memory MEM. The processing element may for example comprise a microcontroller, a DSP, a CPLD, an ASIC or an FPGA with respective interfaces. In a microcontroller or DSP, the functionality of the acquisition processing element ACP may be implemented as computer readable instructions that are executed by a CPU. In a CPLD or FPGA the functionality of the acquisition processing element ACP may be configured in to the CPLD or FPGA opposed to software being executed by a processor.

The processing section PS further comprises a communication processor CP and a communication interface COM.

The communication processor CP may be a device that manages data transfer to and from the oscilloscope OSC. The communication interface COM for any adequate communication standard like for example, Ethernet, WIFI, Bluetooth, NFC, an infra-red communication standard, and a visible-light communication standard.

The communication processor CP is coupled to the memory MEM and may use the memory MEM to store and retrieve data.

Of course, the communication processor CP may also be coupled to any other element of the oscilloscope OSC to retrieve device data or to provide device data that is received from the management server.

The post processing element PPE may be controlled by the acquisition processing element ACP and may access the memory MEM to retrieve data that is to be displayed on the display DISP. The post processing element PPE may condition the data stored in the memory MEM such that the display DISP may show the data e.g., as waveform to a user. The post processing element PPE may also realize analysis functions like cursors, waveform measurements, histograms, or math functions.

The display DISP controls all aspects of signal representation to a user, although not explicitly shown, may comprise any component that is required to receive data to be displayed and control a display device to display the data as required.

It is understood, that even if it is not shown, the oscilloscope OSC may also comprise a user interface for a user to interact with the oscilloscope OSC. Such a user interface may comprise dedicated input elements like for example knobs and switches. At least in part the user interface may also be provided as a touch sensitive display device.

In the oscilloscope OSC, any one of the processing elements in the processing section PS or an additional processing element may perform the function of the measurement device according to the present disclosure or may implement the method according to the present disclosure.

It is understood, that all elements of the oscilloscope OSC that perform digital data processing may be provided as dedicated elements. As alternative, at least some of the above-described functions may be implemented in a single hardware element, like for example a microcontroller, DSP, CPLD or FPGA. Generally, the above-describe logical functions may be implemented in any adequate hardware element of the oscilloscope OSC and not necessarily need to be partitioned into the different sections explained above.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LIST OF REFERENCE SIGNS

S1-S3 method steps
100 measurement device
101 processor
102, 202, 302 measurement audio signal
103 output interface
104 input interface
105 transmitted audio signal
106, 306 audio delay
211 activation sequences
212-1, 212-2 sweep pair
213-1, 213-2 raising frequency audio tone sweep
214-1, 214-2 falling frequency audio tone sweep
215, 315-1, 315-2 final raising sweep
320 cross-talk signal
199 DUT
198 signal path

1. A method comprising:
providing a measurement audio signal to an electronic communication device to be tested;
acquiring a transmitted audio signal at an output section of a signal path, the transmitted audio signal being formed by the measurement audio signal being transmitted by the electronic communication device through the signal path to the output section; and
determining an audio delay based on the measurement audio signal and the transmitted audio signal,
wherein the measurement audio signal comprises:
a predetermined audio activation sequence, and
at least one sweep pair comprising a raising frequency audio tone sweep and a falling frequency audio tone sweep.

2. The method according to claim 1, wherein the measurement audio signal is a continuous signal.

3. The method according to claim 1, wherein the measurement audio signal comprises a sine signal.

4. The method according to claim 1, wherein at least one of a start frequency or an end frequency of at least one of:
the predetermined audio activation sequence,
the raising frequency audio tone sweep of the at least one sweep pair, or
the falling frequency audio tone sweep of the at least one sweep pair is a prime number or a number with a predetermined number of factors.

5. The method according to claim 4, wherein each one of the prime numbers or numbers with a predetermined number of factors is unique in the measurement audio signal.

6. The method according to claim 1, wherein the frequency slopes of the raising frequency audio tone sweep, and the falling frequency audio tone sweep of the at least one sweep pair are unique.

7. The method according to claim 1, wherein the predetermined audio activation sequence comprises at least one of:
a duration between 10 ms and 100 ms;
a frequency between 300 Hz and 700 Hz;
a frequency present in human speech;
a single frequency of a DTMF tone; or
the frequencies of a DTMF tone.

8. The method according to claim 1, wherein the raising frequency audio tone sweep of the at least one sweep pair comprises at least one of:
a duration between 100 ms and 300 ms;
a start frequency between 300 Hz and 700 Hz;
a start frequency that is the same as an end frequency of the predetermined audio activation sequence or a preceding falling frequency audio tone sweep; or
an end frequency between 2500 Hz and 5000 Hz.

9. The method according to claim 1, wherein the falling frequency audio tone sweep of the at least one sweep pair comprises at least one of:
a duration between 50 ms and 150 ms;
a duration that is shorter than that of the raising frequency audio tone sweep;
a start frequency between 2500 Hz and 5000 Hz;
a start frequency that is the same as an end frequency of the raising frequency audio tone sweep; or
an end frequency between 300 Hz and 700 Hz.

10. The method according to claim 1, wherein the measurement audio signal comprises at least two sweep pairs.

11. The method according to claim 1, wherein the measurement audio signal further comprises a final raising sweep after the at least one sweep pair.

12. The method according to claim 11, wherein the final raising sweep comprises at least one of:
a duration of at least 100 ms;
a start frequency between 300 Hz and 700 Hz;
a start frequency that is the same as an end frequency of the preceding falling frequency audio tone sweep; or
an end frequency between 20000 Hz and 30000 Hz.

13. A measurement device for measuring audio delay, the measurement device comprising:
an output interface;
an input interface; and
a processor configured to:
output a measurement audio signal to an electronic communication device to be tested via the output interface,
acquire a transmitted audio signal at an output section of a signal path via the input interface, the transmitted audio signal being formed by the measurement audio signal being transmitted by the electronic communication device through the signal path to the output section, and
determine the audio delay based on the measurement audio signal and the transmitted audio signal,
wherein the processor is further configured to output the measurement audio signal comprising:
a predetermined activation sequence, and
at least one sweep pair comprising a raising frequency audio tone sweep and a falling frequency audio tone sweep.

14. The measurement device according to claim 13, wherein the processor is configured to output the measurement audio signal at least one of:
as a continuous signal;
as a sine signal;
as a signal with the frequency slopes of the raising frequency audio tone sweep, and the falling frequency audio tone sweep of the at least one sweep pair being unique; or
as a signal further comprising at least two sweep pairs.

15. The measurement device according to claim 13, wherein the processor is configured to output the measurement audio signal with at least one of a start frequency and an end frequency of at least one of:
the predetermined activation sequence;
the raising frequency audio tone sweep of the at least one sweep pair; or
the falling frequency audio tone sweep of the at least one sweep pair being a prime number or a number with a predetermined number of factors.

16. The measurement device according to claim 13, wherein the processor is configured to output the measurement audio signal with the predetermined activation sequence comprising at least one of:
a duration between 10 ms and 100 ms;
a frequency between 300 Hz and 700 Hz;
a frequency present in human speech;
a single frequency of a DTMF tone; or
the frequencies of a DTMF tone.

17. The measurement device according to claim 13, wherein the processor is configured to output the measurement audio signal with the raising frequency audio tone sweep of the at least one sweep pair comprising at least one of:
a duration between 100 ms and 300 ms;
a start frequency between 300 Hz and 700 Hz;
a start frequency that is the same as an end frequency of the predetermined activation sequence or a preceding falling frequency audio tone sweep; and
an end frequency between 2500 Hz and 5000 Hz.

18. The measurement device according to claim 13, wherein the processor is configured to output the measurement audio signal with the falling frequency audio tone sweep of the at least one sweep pair comprising at least one of:
a duration between 50 ms and 150 ms;
a duration that is shorter than that of the raising frequency audio tone sweep;
a start frequency between 2500 Hz and 5000 Hz;
a start frequency that is the same as an end frequency of the raising frequency audio tone sweep; and
an end frequency between 300 Hz and 700 Hz.

19. The measurement device according to claim 13, wherein the processor is configured to output the measurement audio signal further comprising a final raising sweep after the at least one sweep pair.

20. The measurement device according to claim 19, wherein the processor is configured to output the measurement audio signal with the final raising sweep comprising at least one of:
a duration of at least 100 ms;
a start frequency between 300 Hz and 700 Hz;
a start frequency that is the same as an end frequency of the preceding falling frequency audio tone sweep; or
an end frequency between 20000 Hz and 30000 Hz.
